(19) United States
(12) Patent Application Publication
(10) Pub. No.: US 2025/0021630 A1
(43) Pub. Date: Jan. 16, 2025

(54) METHODS AND APPARATUS TO PREVENT ATTACKS ON SOFTWARE

(71) Applicant: Intel Corporation, Santa Clara, CA (US)

(72) Inventors: Aviv Barkai, Haifa (IL); Benjamin Zeltser, Haifa (IL); Elad Peer, Yokneam Ilit (IL)

(73) Assignee: Intel Corporation, Santa Clara, CA (US)

(21) Appl. No.: 18/900,225

(22) Filed: Sep. 27, 2024

(51) Int. Cl. G06F 21/12

(52) U.S. Cl. CPC G06F 21/125

(57) ABSTRACT

Systems, apparatus, articles of manufacture, and methods are disclosed to prevent attacks on software. An example non-transitory machine readable storage medium comprising instructions to cause programmable circuitry to at least: insert a plurality of code blocks into an input code; insert replacement manager instructions into the input code, the replacement manager instructions to, when executed: determine a subset of the plurality of code blocks; and insert the subset of the plurality of code blocks into memory for execution during execution of the input code.

### BACKGROUND

Many types of computer software have security implications. Attackers are frequently looking for ways to exploit flaws and attack vectors to interfere with the execution, take control of a computer on which the software is executing, etc. Software developers undertake many approaches to prevent such exploits and attacks.

### BRIEF DESCRIPTION OF THE DRAWINGS

FIG. 1 is a block diagram of an example environment in which an example de-anchoring handler operates to insert de-anchoring instructions into input code to generate output code.

FIGS. 2-4 are flowcharts representative of example machine readable instructions and/or example operations that may be executed, instantiated, and/or performed by example programmable circuitry to implement the de-anchoring handler of FIG. 1.

FIG. 5 illustrates a layout of a portion of memory during execution of the output code.

FIG. 6 is a block diagram of an example processing platform including programmable circuitry structured to execute, instantiate, and/or perform the example machine readable instructions and/or perform the example operations of FIGS. 2-4 to implement the de-anchoring handler of FIG. 1.

FIG. 7 is a block diagram of an example implementation of the programmable circuitry of FIG. 6.

FIG. 8 is a block diagram of another example implementation of the programmable circuitry of FIG. 6.

FIG. 9 is a block diagram of an example software/firmware/instructions distribution platform (e.g., one or more servers) to distribute software, instructions, and/or firmware (e.g., corresponding to the example machine readable instructions of FIGS. 2-4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Physical attacks on software include techniques such as voltage and clock glitching. These attacks involve repetitive attempts to find the timing of critical portions of software during execution to attempt exploitation. This technique to synchronize an exploit with target software is sometimes called anchoring. Methods and apparatus disclosed herein insert random sets of instructions near critical portions of code to prevent such exploitation. In some examples, a first portion of code is inserted into target code that, when executed, chooses random selections of code and inserts that code at a portion of memory that precedes a critical portion of the target code. In some examples, the random selections of code do not substantively change the execution target code in which they are inserted (e.g., do not modify data in registers that are currently in use by the target code).

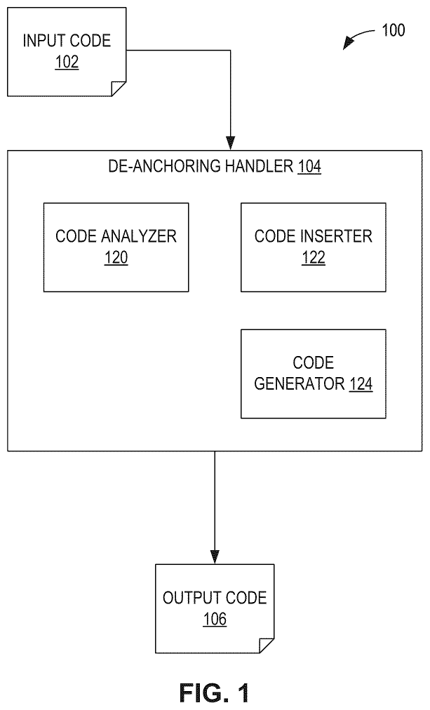

FIG. 1 is a block diagram of an example environment 100 in which an example de-anchoring handler 104 operates to insert de-anchoring instructions into input code 102 to generate output code 106. As used herein, de-anchoring instructions are instructions added to the input code 102 to increase the difficulty in an attacker synchronizing timing with the execution of the code to identify the time at which a critical section is executing (e.g., a section performing an operation related to security, a section performing an operation related to a financial transaction, a section with a vulnerability, etc.).

The example environment 100 of the illustrated example is a software development environment. For example, the de-anchoring handler 104 may be implemented as a plugin within an integrated development environment (IDE). Alternatively, the environment 100 may be any other type of environment in which the input code 102 may be accessed and modified prior to the execution.

The input code 102 of the illustrated example, is high level software instructions that have not yet been compiled. The input code 102 may be any type of programming language, scripting language, etc. The input code 102 may, alternatively, have been compiled or otherwise converted from one form to another prior to operation by the de-anchoring handler 104. The input code 102 includes one or more section of critical code that have been identified by a user/developer. For example, the critical code may be identified using comments in the input code 102, using a separate file or list that identifies the critical code using any type of identifier, etc.

The de-anchoring handler 104 processes the input code 102 to insert de-anchoring software and instructions. The example de-anchoring handler 104 includes an example code analyzer 120, an example code inserter 122, and an example code generator 124.

The example code analyzer 120 accesses the input code 102 to identify critical code. In some examples, the critical code has been identified in the input code 102 by a user/developer. Additionally or alternatively, the code analyzer 120 may provide a user interface in which a user/developer may identify critical code. In other examples, the code analyzer 120 may utilize a set of rules, operations, algorithms, functions, processes, etc. to identify the critical code. For example, certain types of instructions or groups of instructions may be identified as critical code and the code analyzer 120 may search the input code 102 for such critical code.

The example code inserter 122 modifies the input code 102 to insert replacement manager instructions (e.g., instructions in the same programming language that is used in input code 102), insert instruction sequences, insert a de-anchoring section, and insert instructions to restore the de-anchoring instruction. The example code inserter 122 inserts the replacement manager instructions, instruction sequences, and de-anchoring section adjacent and prior-to each critical code section. Alternatively, the code inserter 122 may insert elements at other locations and/or at less than each of the critical code sections. For example, the code inserter 122 may insert a single instance of the replacement manager instructions that will handle configuring de-anchoring sections that are adjacent to each of the critical code sections. The replacement manager instructions include code that replaces the de-anchoring section contents with sequence(s) from the instruction sequences section. In some examples, the replacement manager instructions insert NOPs between these sequences. The de-anchoring section starts with benign instructions and is later filled with instruction sequences to de-anchor a potential attack. The restoration instructions contain code that restores the benign instructions to the de-anchoring section.

The example code generator 124 generates instructions to be inserted into the input code 102 as the code sequences (e.g., inserted by the code inserter 122). According to the illustrated example, the code generator 125 generates a plurality of instruction sequences that the replacement manager instructions may select among (e.g., randomly) to be inserted into the de-anchoring section. By selecting a subset of the instruction sequences for insertion, the de-anchoring handler 104 can make it difficult for an attacker to find patterns for identifying the critical code sections (e.g., because the de-anchoring section can be changed for each execution, during each execution, etc.). The example code generator 124 generates numerous short instruction sequences that do not affect the previously stored resources. These sequences may be smaller or equal to the size of the de-anchoring section, have varying sizes, and ultimately do not change the computation results. The example code generator 124 analyzes the input code 102 and the registers, memory, etc. that is in use to generate instruction sequences that will not affect those resources and, thus, not affect the original operation of the input code 102.

The output code 106 is the input code 102 that has been augmented by the de-anchoring handler 104. According to the illustrated example, the output code 106 includes replacement manager instructions, instructions sequences, a de-anchoring section, and restoration instructions. The output code 106 may include one or more of each of the addition sequences/sections. Alternatively, the output code 106 may not include all of the sequences/sections. For example, in some examples the restoration instructions may not be included.

The de-anchoring handler 104 of FIG. 1 includes blocks 120-124 as a block diagram of an example implementation of the de-anchoring handler 104 of FIG. 1 to do modify input code to include de-anchoring functionality. The de-anchoring handler 104 of FIG. 1 may be instantiated (e.g., creating an instance of, bring into being for any length of time, materialize, implement, etc.) by programmable circuitry such as a Central Processor Unit (CPU) executing first instructions. Additionally or alternatively, the de-anchoring handler 104 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

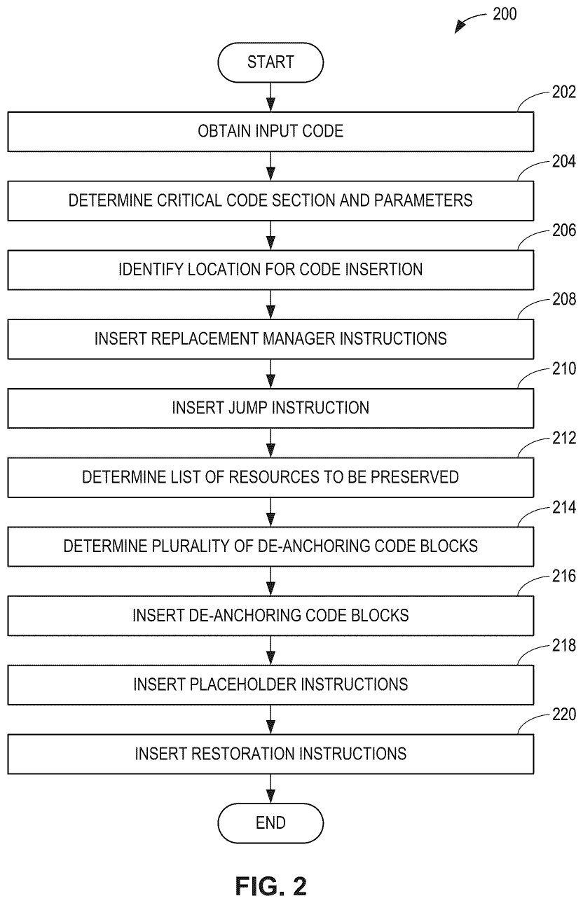

In some examples, the code analyzer circuitry 120 is instantiated by programmable circuitry executing code analyzer instructions and/or configured to perform operations such as those represented by the flowcharts of FIGS. 2-4.

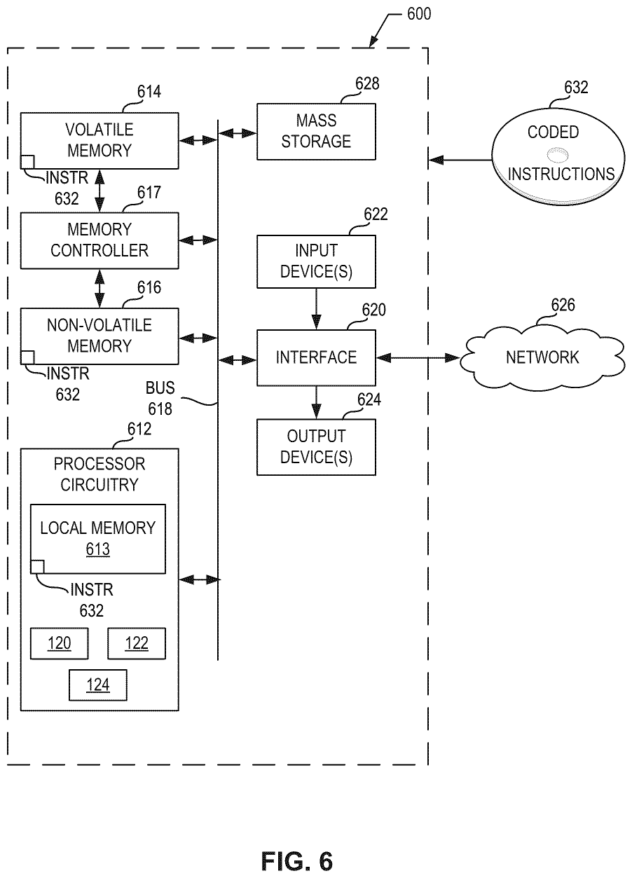

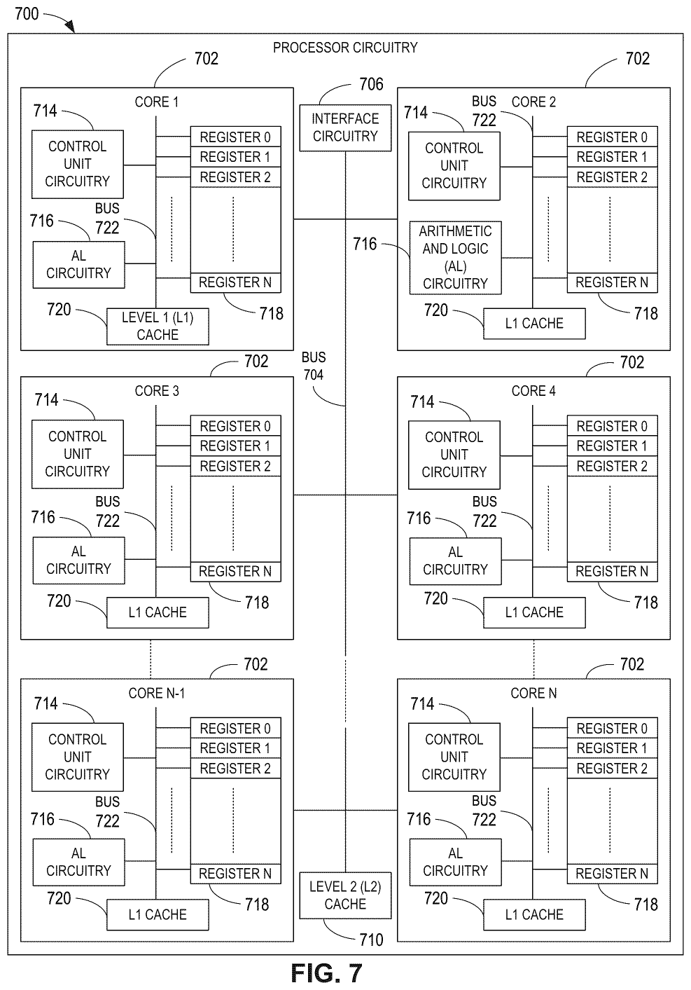

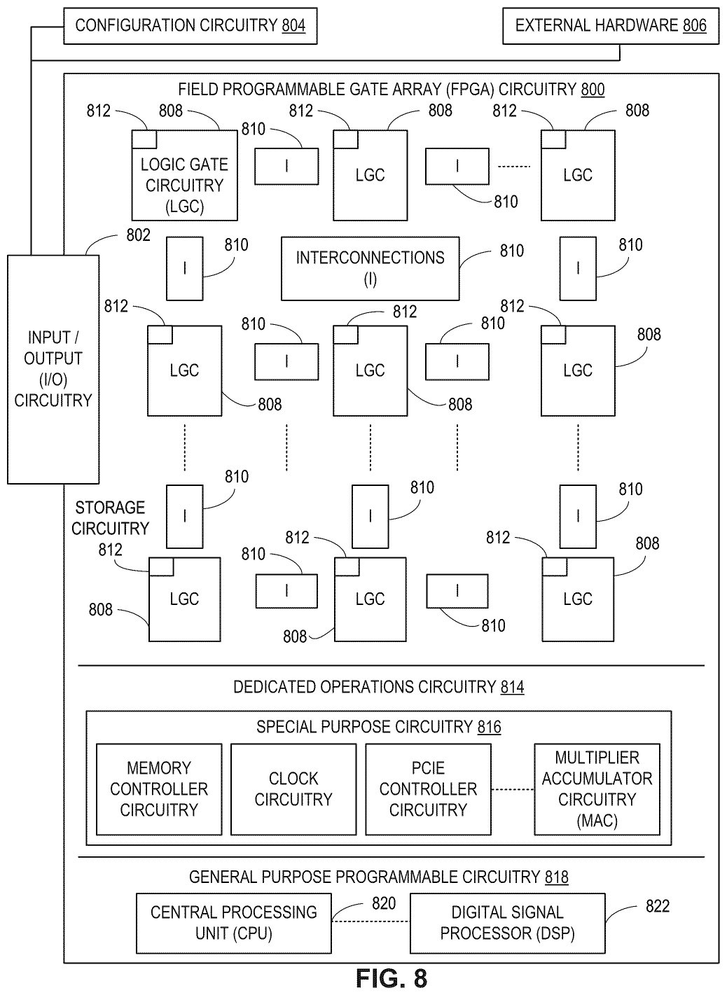

In some examples, the de-anchoring handler 104 includes means for analyzing code. For example, the means for analyzing code may be implemented by the code analyzer circuitry 120. In some examples, the code analyzer circuitry 120 may be instantiated by programmable circuitry such as the example programmable circuitry 612 of FIG. 6. For instance, the code analyzer circuitry 120 may be instantiated by the example microprocessor 700 of FIG. 7 executing machine executable instructions such as those implemented by at least blocks 202-206 of FIG. 2. In some examples, the code analyzer circuitry 120 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the code analyzer circuitry 120 may be instantiated by any other combination of hardware, software, and/or firmware. For example, the code analyzer circuitry 120 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the code inserter circuitry 122 is instantiated by programmable circuitry executing code insertion instructions and/or configured to perform operations such as those represented by the flowcharts of FIGS. 2-4.

In some examples, the de-anchoring handler 104 includes means for code insertion. For example, the means for code insertion may be implemented by the code inserter circuitry 122. In some examples, the code inserter circuitry 122 may be instantiated by programmable circuitry such as the example programmable circuitry 612 of FIG. 6. For instance, the code inserter circuitry 122 may be instantiated by the example microprocessor 700 of FIG. 7 executing machine executable instructions such as those implemented by at least blocks 208-210 and 216-220 of FIG. 2. In some examples, the code inserter circuitry 122 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the code inserter circuitry 122 may be instantiated by any other combination of hardware, software, and/or firmware. For example, the code inserter circuitry 122 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the code generator circuitry 124 is instantiated by programmable circuitry executing code generation instructions and/or configured to perform operations such as those represented by the flowcharts of FIGS. 2-4.

In some examples, the de-anchoring handler 104 includes means for code generation. For example, the means for code generation may be implemented by the code generator circuitry 124. In some examples, the code generator circuitry 124 may be instantiated by programmable circuitry such as the example programmable circuitry 612 of FIG. 6. For instance, the code generator circuitry 124 may be instantiated by the example microprocessor 700 of FIG. 7 executing machine executable instructions such as those implemented by at least blocks 212-214 of FIG. 2. In some examples, the code generator circuitry 124 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the code generator circuitry 124 may be instantiated by any other combination of hardware, software, and/or firmware. For example, the code generator circuitry 124 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the de-anchoring handler 104 of FIG. 1 is illustrated in FIG. 1, one or more of the elements, processes, and/or devices illustrated in FIG. 1 may be combined, divided, re-arranged, omitted, eliminated, and/or implemented in any other way. Further, the code analyzer circuitry 120, the example code inserter circuitry 122, the example code generator circuitry 124, and/or, more generally, the example de-anchoring handler 104 of FIG. 1, may be implemented by hardware alone or by hardware in combination with software and/or firmware. Thus, for example, any of the code analyzer circuitry 120, the example code inserter circuitry 122, the example code generator circuitry 124, and/or, more generally, the example de-anchoring handler 104 of FIG. 1, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example de-anchoring handler 104 of FIG. 1 may include one or more elements, processes, and/or devices in addition to, or instead of, those illustrated in FIG. 1, and/or may include more than one of any or all of the illustrated elements, processes and devices.

Flowchart(s) representative of example machine readable instructions, which may be executed by programmable circuitry to implement and/or instantiate the de-anchoring handler 104 of FIG. 1 and/or representative of example operations which may be performed by programmable circuitry to implement and/or instantiate the de-anchoring handler 104 of FIG. 1, are shown in FIGS. 2-4. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 2-4, many other methods of implementing the example de-anchoring handler 104 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 2-4 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 2 is a flowchart representative of example machine readable instructions and/or example operations 200 that may be executed, instantiated, and/or performed by programmable circuitry to augment input code with de-anchoring functionality. The example machine-readable instructions and/or the example operations 200 of FIG. 2 begin at block 202, at which the code analyzer 120 obtains input code (e.g., the input code 102 of FIG. 1). The example code analyzer 120 determines critical code sections and parameters of the input code (block 204). The example code analyzer 120 identifies locations for code insertion (e.g., adjacent to the critical code sections) (block 206).

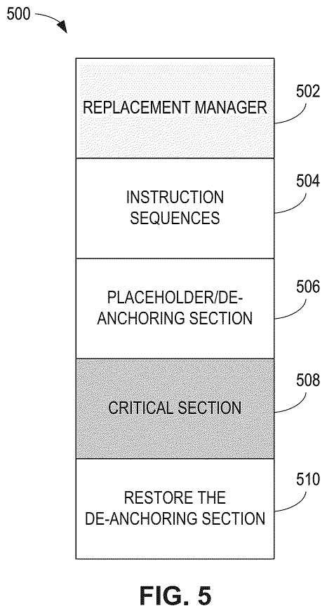

The example code inserter 122 then inserts replacement manager instructions into the input code at the identified location(s) (block 208). The example code inserter 122 also inserts a jump instruction following the replacement manager instructions (block 210). For example, the jump instruction will cause execution of the input code to jump over the plurality of code sequences that are stored in the code for selection by the replacement manager instructions as illustrated in FIG. 5.

The example code generator 124 determines a list of resources to be preserved (e.g., registers, memory locations, variables, etc.) (block 212). For example, the list of resources to be preserved may include resources that are utilized by the original input code 102, utilized by a soon-to-be executed portion of the input code 102, utilized by other processes, etc. The example code generator 124 determines a plurality of de-anchoring code blocks/instruction sequences (block 214). For example, the code generator 124 may access a predefined library of instructions to select instructions that are appropriate for the input code 102, may utilize a machine learning algorithm to generate instructions that are suitable and will not substantially affect operation of the input code 102, may query a user to input instructions, etc. In some examples, a sufficient number of instructions will be stored so that during execution of the output code 106, the replacement manager instructions can select a subset of the instructions for insertion so that the de-anchoring section of the code will change (e.g., during each execution of the output code 106, during each execution of a particular critical code section, etc.).

The example code inserter 122 inserts the de-anchoring code blocks into the input code 102 (block 216). The example code inserter 122 also inserts a section of placeholder instructions into the input code (block 218). For example, the placeholder instructions will provide a section of the memory into which the replacement manager instructions will insert the subset of the de-anchoring code blocks during execution. By inserting placeholder instructions, it will be more difficult for an attacker to location the critical section than if an empty section of memory was present for code insertion.

According to the illustrated example, the code inserter 122 also inserts restoration instructions into the input code 102 (block 220). For example, the restoration instructions will, after the critical code section is executed, revert the memory to include the placeholder instructions that were replaced by the replacement manager instructions. In some examples, where restoration is not utilized, block 220 may not be included.

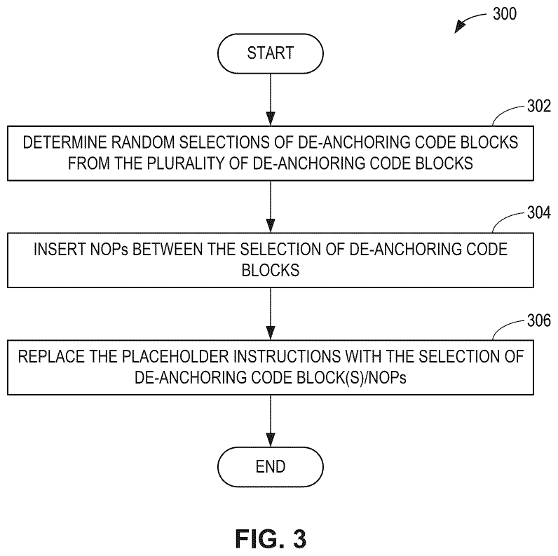

FIG. 3 is a flowchart representative of example machine readable instructions and/or example operations 300 that may be executed, instantiated, and/or performed by programmable circuitry to implement the replacement manager instructions (e.g., during execution of the output code 106 that includes the replacement manager instructions). The example machine-readable instructions and/or the example operations 300 of FIG. 3 begin at block 302 at which the replacement manager instructions determine random selections of de-anchoring code blocks from the plurality of de-anchoring code blocks inserted into the output code 106. The replacement manager instructions then insert NOPs or other non-operational instructions that do nothing between blocks of instructions in the subset of de-anchoring code blocks (block 304). For example, block 304 may be performed only when the size of the subset of the de-anchoring code blocks does not match the size of the placeholder instruction section in the output code 106.

The example replacement manager instructions then replace the placeholder instructions in memory with the subset of the de-anchoring blocks/NOPs (block 306). According, when execution of the output code 106 reaches the section originally containing the placeholder instructions, the execution will execute the subset of the de-anchoring blocks/NOPs instead of the placeholder instructions.

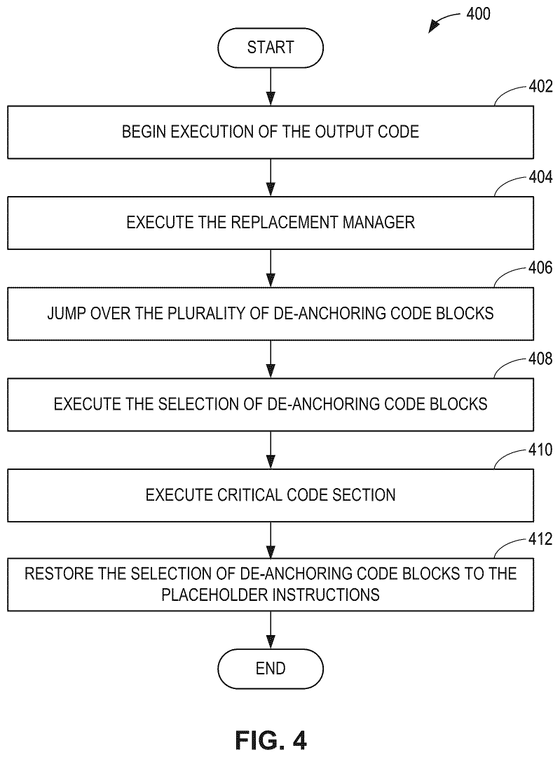

FIG. 4 is a flowchart representative of example machine readable instructions and/or example operations 400 that may be executed, instantiated, and/or performed by programmable circuitry during execution of the output code 106 that has been augmented with the de-anchoring instructions and the replacement manager instructions. The example machine-readable instructions and/or the example operations 400 of FIG. 4 begin at block 402 at which execution of the output code 106 begins (block 402). For example, the output code 106 may be distributed to an end user for execution on their computing device.

During execution of the output code 106, the execution reaches the portion of the code at which the replacement manager instructions have been inserted and the replacement manager instructions are then executed (block 402). The execution then reaches the jump instructions and then jumps over the inserted plurality of de-anchoring code block (block 406). For example, as shown in FIG. 5, the plurality of de-anchoring code blocks is inserted for selection, but is not intended to be executed unless it is selected and inserted to replace the placeholder instructions.

The execution then reaches the subset of de-anchoring code blocks (e.g., where the placeholder instructions were previously located) and the subset of de-anchoring code blocks are executed (block 408). The critical code section is then executed (block 410). If the output code 106 includes the restoration instructions, the restoration instructions are then executed to restore the placeholder instructions in place of the subset of de-anchoring code blocks (block 412).

FIG. 5 illustrates a layout of a portion of memory 500 during execution of the output code 106. According to the illustrated example, the portion of memory includes 5 sections: replacement manger instructions 502, instructions sequences 504, de-anchoring 506, critical code 508, and restoration 510. During execution of the output code 106, the execution follows the order of the portion of memory 500 starting with section 502 and proceeding through to section 510. As described earlier, a jump instruction is included at the end of the replacement manger instructions 502 to cause execution to from over block 504 so that the instruction sequences are not executed and, instead, the subset of instruction sequences that are inserted into the de-anchoring section are executed.

FIG. 6 is a block diagram of an example programmable circuitry platform 600 structured to execute and/or instantiate the example machine-readable instructions and/or the example operations of FIGS. 2-4 to implement the de-anchoring handler 104 of FIG. 1. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the code analyzer 120, the code inserter 122, and the code generator 124.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 2-4, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 2-4 to effectively instantiate the circuitry of FIG. 2 as logic circuits to perform operations corresponding to those machine readable instructions. In some such examples, the circuitry of FIG. 1 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 2-4.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 2-4 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 2-4. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 2-4. As such, the FPGA circuitry 800 may be configured and/or structured to effectively instantiate some or all of the operations/functions corresponding to the machine readable instructions of the flowchart(s) of FIGS. 2-4 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 2-4 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 2-4 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 2-4 to perform first operation(s)/function(s), the FPGA circuitry 800 of FIG. 8 may be configured and/or structured to perform second operation(s)/function(s) corresponding to a second portion of the machine readable instructions represented by the flowcharts of FIGs. 2-4, and/or an ASIC may be configured and/or structured to perform third operation(s)/function(s) corresponding to a third portion of the machine readable instructions represented by the flowcharts of FIGS. 2-4.

It should be understood that some or all of the circuitry of FIG. 1 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 1 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 1 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

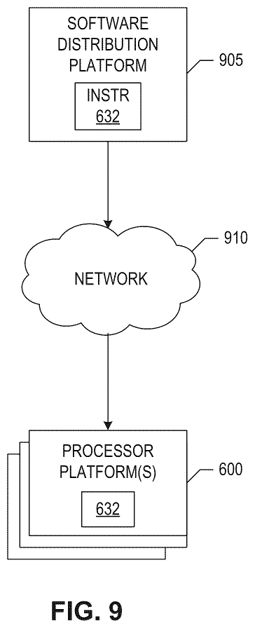

A block diagram illustrating an example software distribution platform 905 to distribute software such as the example machine readable instructions 632 of FIG. 6 to other hardware devices (e.g., hardware devices owned and/or operated by third parties from the owner and/or operator of the software distribution platform) is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform 905. For example, the entity that owns and/or operates the software distribution platform 905 may be a developer, a seller, and/or a licensor of software such as the example machine readable instructions 632 of FIG. 6. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the machine readable instructions 632, which may correspond to the example machine readable instructions of FIGS. 2-4, as described above. The one or more servers of the example software distribution platform 905 are in communication with an example network 910, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 632 from the software distribution platform 905. For example, the software, which may correspond to the example machine readable instructions of FIG. 2-4, may be downloaded to the example programmable circuitry platform 600, which is to execute the machine readable instructions 632 to implement the de-anchoring handler 104. In some examples, one or more servers of the software distribution platform 905 periodically offer, transmit, and/or force updates to the software (e.g., the example machine readable instructions 632 of FIG. 6) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to within 1 second of real time.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

Example methods, apparatus, systems, and articles of manufacture to prevent attacks on software are disclosed herein. Further examples and combinations thereof include the following:
Example 1 includes a non-transitory machine readable storage medium comprising instructions to cause programmable circuitry to at least insert a plurality of code blocks into an input code, and insert replacement manager instructions into the input code, the replacement manager instructions to, when executed determine a subset of the plurality of code blocks, and insert the subset of the plurality of code blocks into memory for execution during execution of the input code.
Example 2 includes the non-transitory machine readable storage medium of example 1, wherein the instructions are further to cause programmable circuitry to insert placeholder instructions in the input code.
Example 3 includes the non-transitory machine readable storage medium of any of the foregoing examples, wherein the instructions are to cause the programmable circuitry to insert the replacement manager into the input code prior to compilation of the input code.
Example 4 includes the non-transitory machine readable storage medium of any of the foregoing examples, wherein the instructions are to cause the programmable circuitry to determine a critical code section of the input code, wherein the replacement manager instructions are to insert the subset of the plurality of code blocks into the memory for execution ahead of the critical code section.
Example 5 includes the non-transitory machine readable storage medium of any of the foregoing examples, wherein the instructions are to cause the programmable circuitry to determine a random subset of the plurality of code blocks.
Example 6 includes the non-transitory machine readable storage medium of any of the foregoing examples, wherein the instructions are to cause the programmable circuitry to insert restoration instructions into the input code to replace the inserted plurality of code blocks after they are executed.
Example 7 includes the non-transitory machine readable storage medium of any of the foregoing examples, wherein the replacement manager instructions are to, when executed, determine a second subset of the plurality of code blocks during a second execution of the input code.
Example 8 includes an apparatus comprising computer readable instructions, and programmable circuitry to at least one of instantiate or execute the computer readable instructions to insert a plurality of code blocks into an input code, and insert replacement manager instructions into the input code, the replacement manager instructions to, when executed determine a subset of the plurality of code blocks, and insert the subset of the plurality of code blocks into a de-anchoring section of memory for execution during execution of the input code.
Example 9 includes the apparatus of example 8, wherein the computer readable instructions are further to cause programmable circuitry to insert placeholder instructions in the input code.
Example 10 includes the apparatus of any of examples 8-9, wherein the computer readable instructions are to cause the programmable circuitry to insert the replacement manager into the input code prior to compilation of the input code.
Example 11 includes the apparatus of examples 8-10, wherein the computer readable instructions are to cause the programmable circuitry to determine a critical code section of the input code, wherein the replacement manager instructions are to insert the subset of the plurality of code blocks into the memory for execution ahead of the critical code section.
Example 12 includes the apparatus of examples 8-11, wherein the computer readable instructions are to cause the programmable circuitry to determine a random subset of the plurality of code blocks.
Example 13 includes the apparatus of examples 8-12, wherein the computer readable instructions are to cause the programmable circuitry to insert restoration instructions into the input code to replace the inserted plurality of code blocks after they are executed.
Example 14 includes the apparatus of examples 8-13, wherein the replacement manager instructions are to, when executed, determine a second subset of the plurality of code blocks during a second execution of the input code.
Example 15 includes a non-transitory machine readable storage medium comprising computer readable instructions to cause programmable circuitry to at least determine a subset of a plurality of first instructions in memory, replace second instructions in the memory with the subset of the plurality of first instructions, and execute the subset of the plurality of first instructions prior to execution of third instructions identified for de-anchoring.
Example 16 includes the non-transitory machine readable storage medium of example 15, wherein the computer readable instructions, when executed, cause the programmable circuitry to determine a second subset of the first instructions during a second execution of the third instructions.
Example 17 includes the non-transitory machine readable storage medium of any of examples 15-16, wherein the computer readable instructions, when executed, cause the programmable circuitry to insert non-operational instructions between sections of the subset of the first instructions.
Example 18 includes the non-transitory machine readable storage medium of any of examples 15-17, wherein the second instructions are placeholder instructions.
Example 19 includes the non-transitory machine readable storage medium of any of examples 15-18, wherein the computer readable instructions, when executed, cause the programmable circuitry to re-insert the placeholder instructions after execution of the third instructions.
Example 20 includes the non-transitory machine readable storage medium of any of examples 15-19, wherein the first instructions operate on computing resources that are not utilized by the third instructions.

From the foregoing, it will be appreciated that example systems, apparatus, articles of manufacture, and methods have been disclosed that implement a de-anchoring technique in software instructions. For example, such a de-anchoring technique my prevent attackers from synchronizing with such software and identifying a location of critical code during execution of the instructions. Disclosed systems, apparatus, articles of manufacture, and methods improve the efficiency of using a computing device by performing replacement of instructions during execution. Disclosed systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. A non-transitory machine readable storage medium comprising instructions to cause programmable circuitry to at least:
insert a plurality of code blocks into an input code; and
insert replacement manager instructions into the input code, the replacement manager instructions to, when executed:
determine a subset of the plurality of code blocks; and
insert the subset of the plurality of code blocks into memory for execution during execution of the input code.

2. The non-transitory machine readable storage medium of claim 1, wherein the instructions are further to cause programmable circuitry to insert placeholder instructions in the input code.

3. The non-transitory machine readable storage medium of claim 1, wherein the instructions are to cause the programmable circuitry to insert the replacement manager into the input code prior to compilation of the input code.

4. The non-transitory machine readable storage medium of claim 1, wherein the instructions are to cause the programmable circuitry to determine a critical code section of the input code, wherein the replacement manager instructions are to insert the subset of the plurality of code blocks into the memory for execution ahead of the critical code section.

5. The non-transitory machine readable storage medium of claim 1, wherein the instructions are to cause the programmable circuitry to determine a random subset of the plurality of code blocks.

6. The non-transitory machine readable storage medium of claim 1, wherein the instructions are to cause the programmable circuitry to insert restoration instructions into the input code to replace the inserted plurality of code blocks after they are executed.

7. The non-transitory machine readable storage medium of claim 1, wherein the replacement manager instructions are to, when executed, determine a second subset of the plurality of code blocks during a second execution of the input code.

8. An apparatus comprising:
computer readable instructions; and
programmable circuitry to at least one of instantiate or execute the computer readable instructions to:
insert a plurality of code blocks into an input code; and
insert replacement manager instructions into the input code, the replacement manager instructions to, when executed:
determine a subset of the plurality of code blocks; and
insert the subset of the plurality of code blocks into a de-anchoring section of memory for execution during execution of the input code.

9. The apparatus of claim 8, wherein the computer readable instructions are further to cause programmable circuitry to insert placeholder instructions in the input code.

10. The apparatus of claim 8, wherein the computer readable instructions are to cause the programmable circuitry to insert the replacement manager into the input code prior to compilation of the input code.

11. The apparatus of claim 8, wherein the computer readable instructions are to cause the programmable circuitry to determine a critical code section of the input code, wherein the replacement manager instructions are to insert the subset of the plurality of code blocks into the memory for execution ahead of the critical code section.

12. The apparatus of claim 8, wherein the computer readable instructions are to cause the programmable circuitry to determine a random subset of the plurality of code blocks.

13. The apparatus of claim 8, wherein the computer readable instructions are to cause the programmable circuitry to insert restoration instructions into the input code to replace the inserted plurality of code blocks after they are executed.

14. The apparatus of claim 8, wherein the replacement manager instructions are to, when executed, determine a second subset of the plurality of code blocks during a second execution of the input code.

15. A non-transitory machine readable storage medium comprising computer readable instructions to cause programmable circuitry to at least:
determine a subset of a plurality of first instructions in memory;
replace second instructions in the memory with the subset of the plurality of first instructions; and
execute the subset of the plurality of first instructions prior to execution of third instructions identified for de-anchoring.

16. The non-transitory machine readable storage medium of claim 15, wherein the computer readable instructions, when executed, cause the programmable circuitry to determine a second subset of the first instructions during a second execution of the third instructions.

17. The non-transitory machine readable storage medium of claim 15, wherein the computer readable instructions, when executed, cause the programmable circuitry to insert non-operational instructions between sections of the subset of the first instructions.

18. The non-transitory machine readable storage medium of claim 15, wherein the second instructions are placeholder instructions.

19. The non-transitory machine readable storage medium of claim 18, wherein the computer readable instructions, when executed, cause the programmable circuitry to re-insert the placeholder instructions after execution of the third instructions.

20. The non-transitory machine readable storage medium of claim 15, wherein the first instructions operate on computing resources that are not utilized by the third instructions.
